(19) United States
(12) Patent Application Publication
(10) Pub. No.: US 2004/0122120 A1
(43) Pub. Date: Jun. 24, 2004

(54) Crosslinked polyolefin-based resin foam, process for producing the same, and interior material for automobiles

(76) Inventor: Eiji Tateo, Hasuda-shi (JP)

Correspondence Address: KUBOVCIK & KUBOVCIK, SUITE 710, 900 17TH STREET NW, WASHINGTON, DC, 20006

(21) Appl. No.: 10/326,605

(22) Filed: Dec. 23, 2002

(51) Int. Cl. C08F 110/00

(52) U.S. Cl. 521/143

(57) ABSTRACT

A crosslinked polyolefin-based resin foam according to the present invention comprises a polyolefin-based resin containing 20 to 60% by weight of a polyethylene-based resin, and the crosslinked polyolefin-based resin foam has the melting energy of 28 to 50 mJ/mg at 140° C. or more contained in the melting energy per unit weight (calorific value obtained from the area of its melting peak in differential scanning calorimetry/weight).

### FIELD OF THE INVENTION

The present invention relates to a crosslinked polyolefin-based resin foam excellent in heat resistance and moldability and used preferably in interior materials for automobiles, and a producing process thereof, as well as an interior material for automobiles which uses the crosslinked polyolefin-based resin foam.

### BACKGROUND OF THE INVENTION

Conventionally, a crosslinked polyolefin-based resin foam has been used as an insulating material, a cushioning material and the like in various fields. In particular, the crosslinked polyolefin-based resin foam is used as an insulating, cushioning material in interior materials such as a ceiling material, a door, an indoor panel and an air conditioner cover in the field of automobiles.

For use in interior materials for automobiles, a skin material such as soft polyvinyl chloride-based resin sheet, thermoplastic elastomer sheet, cloth or synthetic leather is laminated integrally on the crosslinked polyolefin-based resin foam to form a composite sheet, and this composite sheet is molded by molding techniques such as vacuum molding and stamping molding to form a molded article in a desired shape.

The stamping molding is a molding process which involves feeding a molten thermoplastic resin as a base material to the side of the crosslinked polyolefin-based resin foam in the above composite sheet and then molding the composite sheet and the molten thermoplastic resin into a molded article of desired shape in a cavity formed between male and female molds, and simultaneously laminating a base layer made of the thermoplastic resin integrally on the crosslinked polyolefin-based resin foam in the composite sheet.

However, when the composite sheet is molded, there arise problems such as sheet cutting i.e., breakage of the crosslinked polyolefin-based resin foam at the corner of the molded article receiving strong force, or the like, or breakage of air bubbles in the crosslinked polyolefin-based resin foam, to make the surface of the skin material uneven with pockmarks.

In stamping molding, there arise problems such as resin leakage in which the molten thermoplastic resin breaks through the surface of the crosslinked polyolefin-based resin foam, to invade the foam, or the failure of the crosslinked polyolefin-based resin foam to recover the original thickness after molding, to make the resulting molded article poor in flexibility and cushioning properties.

Accordingly, Japanese Unexamined Patent Publication No. 10-45975 (1998) proposes a crosslinked polyethylene-based resin foam comprising 1 to 7% by weight homopolypropylene to polypropylene having ethylene or butene copolymerized therein and polyethylene having α-olefin copolymerized therein.

However, this prior art does not completely solve the problems described above because the crosslinked polyethylene-based resin foam is poor in elongation at the time of molding, and thus air bubbles in the crosslinked polyethylene-based resin foam are broken to make the surface of the skin material uneven with pockmarks, while in stumping molding, resin leakage occurs, or the thickness of the crosslinked polyolefin-based resin foam is not recovered after molding, and thus the molded article is poor in flexibility and cushioning properties.

### SUMMARY OF THE INVENTION

The present invention provides a crosslinked polyolefin-based resin foam which can be used particularly preferably as an interior material for automobiles, which is excellent in heat resistance, flexibility and cushioning properties, hardly causes sheet cutting and resin leakage at the time of molding, and even upon molding with a skin material laminated integrally on one side thereof, does not make the surface of the skin material uneven with pockmarks, as well as a process of producing the same and an interior material for automobiles which comprises the crosslinked polyolefin-based resin foam.

A crosslinked polyolefin-based resin foam according to claim 1 comprises a polyolefin-based resin which contains 20 to 60% by weight of a polyethylene-based resin, and the crosslinked polyolefin-based resin foam has the melting energy of 28 to 50 mJ/mg at 140° C. or more contained in the melting energy per unit weight (calorific value obtained from the area of its melting peak in differential scanning calorimetry/weight).

A crosslinked polyolefin-based resin foam according to claim 2 is the crosslinked polyolefin-based resin foam according to claim 1 comprising 7 to 40% by weight of isotactic homopolypropylene having a melt index of 1 to 30 g/10 min.

A crosslinked polyolefin-based resin foam according to claim 3 is the crosslinked polyolefin-based resin foam according to claim 1 wherein the elongation of the resin foam is 200 to 400% at 20° C. and 130 to 300% at 160° C., and the strength at 100% elongation is 0.25 to 0.40 MPa at 120° C. and 0.07 to 0.20 MPa at 160° C.

A process for producing crosslinked polyolefin-based resin foam according to claim 4 comprises feeding 100 parts by weight of a polyolefin-based resin containing 20 to 60% by weight of a polyethylene-based rein and 1 to 50 parts by weight of a thermally degradable foaming agent to an extruder, melting and kneading the mixture, extruding it into a foamable sheet, irradiating at least one side of the foamable sheet simultaneously or separately with a low-energy ionizable radiation at an accelerating voltage of 200 to 400 kV and a high-energy ionizable radiation at a higher accelerating voltage than that of the low-energy ionizable radiation, to crosslink the foamable sheet, and foaming the foamable sheet by heating at a temperature higher than the decomposition temperature of the thermally degradable foaming agent, to produce a crosslinked polyolefin-based resin foam having 28 to 50 mJ/mg of the melting energy at 140° C. or more contained in the melting energy per unit weight (calorific value obtained from the area of its melting peak in differential scanning calorimetry/weight).

Finally, an interior material for automobiles according to claim 5 comprises a skin material laminated integrally on one side of a crosslinked polyolefin-based resin foam and a base layer made of thermoplastic resin laminated integrally on the other side, the crosslinked polyolefin-based resin foam comprises a polyolefin-based resin containing 20 to 60% by weight of a polyethylene-based resin, and the crosslinked polyolefin-based resin foam has the melting energy of 28 to 50 mJ/mg at 140° C. or more contained in the melting energy per unit weight (calorific value obtained from the area of its melting peak in differential scanning calorimetry/weight) .

### ADVANTAGES OF THE INVENTION

The crosslinked polyolefin-based resin foam according to claim 1 is excellent in heat resistance, elongation, flexibility and cushioning properties and superior in form stability without generating breakage during molding or generating warp in its molded article.

Even if the crosslinked polyolefin-based resin foam having a skin material laminated integrally on one side thereof is molded, the surface of the skin material is not made uneven with pockmarks.

Further, even if the crosslinked polyolefin-based resin foam is molded by stamping molding, a molten resin does not penetrate into the crosslinked polyolefin-based resin foam, so it can be preferably used as an interior material for automobiles.

The crosslinked polyolefin-based resin foam according to claim 2 comprises isotactic homopolypropylene of specific melt index, and thus has excellent strength at high temperatures and uniform air bubbles.

The crosslinked polyolefin-based resin foam according to claim 3 is excellent in flexibility in the molding direction at the time of molding, and thus the crosslinked polyolefin-based resin foam can be certainly prevented from being broken at a highly deformed portion of its molded article.

Further, the process for producing crosslinked polyolefin-based resin foam according to claim 4 comprises irradiation with a low-energy ionizable radiation and a high-energy ionizable radiation, and thus crosslinked polyolefin-based resin foam excellent in molding processability can be easily produced by controlling the quantity of the radiations.

Finally, the interior material for automobiles according to claim 5 comprises the crosslinked polyolefin-based resin foam described above, and is thus excellent in cushioning properties and outward appearance and free of inconveniences such as warp.

### BRIEF DESCRIPTION OF THE DRAWING

FIG. 1 is a graph showing one example of a melting peak curve of a crosslinked polyolefin-based resin foam.

### DETAILED DESCRIPTION OF THE PREFERRED EMBODIMENTS

A crosslinked polyolefin-based resin foam according to the present invention comprises a polyolefin-based resin containing 20 to 60% by weight of a polyethylene-based resin, and the crosslinked polyolefin-based resin foam has the melting energy of 28 to 50 mJ/mg at 140° C. or more contained in the melting energy per unit weight (calorific value obtained from the area of its melting peak in differential scanning calorimetry/weight).

Examples of the polyethylene-based resin include linear low-density polyethylene, low-density polyethylene, medium-density polyethylene, high-density polyethylene, a copolymer of α-olefin containing at least 50% by weight of ethylene, and the like, among which linear low-density polyethylene is preferable. These polyethylene-based resins may be used alone or in combination thereof.

The copolymer of α-olefin containing at least 50% by weight of ethylene may be a random copolymer or a block copolymer. Examples of the α-olefin include propylene, 1-butene, 1-pentene, 4-methyl-1-pentene, 1-hexene, 1-heptene, 1-octene and the like.

The content of the polyethylene-based resin in the polyolefin-based resin is limited to 20 to 60% by weight because if its content is too low, the resulting crosslinked polyolefin-based resin foam is poor in flexibility, elongation and the like, to undergo sheet cutting, resin leakage or the like during molding, while if the content is too high, the resulting crosslinked polyolefin-based resin foam is poor in heat resistance, to undergo sheet cutting, resin leakage or the like during molding.

Among polyolefin-based resins, examples of resins other than the above-mentioned polyethylene-based resins include polypropylene-based resin, polybutene-based resin and the like, among which polypropylene-based resin is preferable. These resins may be used alone or in combination thereof.

Examples of the polypropylene-based resin include homopolypropylene and a copolymer of α-olefin containing at least 50% by weight of propylene, and the like, among which homopolypropylene is preferable and isotactic homopolypropylene is more preferable. These polypropylene-based resins may be used alone or in combination thereof.

The copolymer of α-olefin containing at least 50% by weight of propylene may be a random copolymer or a block copolymer. Examples of the α-olefin include ethylene, 1-butene, 1-pentene, 4-methyl-1-pentene, 1-hexene, 1-heptene, 1-octene and the like.

The content of a resin component other than the polyethylene-based resin in the polyolefin-based resin is limited to 40 to 80% by weight because if its content is too low, the resulting crosslinked polyolefin-based resin foam is poor in heat resistance, to undergo sheet cutting, resin leakage or the like during molding, while if the content is too high, the resulting crosslinked polyolefin-based resin foam is poor in flexibility, elongation and the like, to undergo sheet cutting, resin leakage or the like during molding.

If the melt index (hereinafter, referred to as “MI”) of the isotactic homopolypropylene is too low, the melt viscosity is increased, and primary foaming occurs easily upon extrusion through an extruder, thus failing to give an excellent foam sheet, and as a result, the resulting crosslinked polyolefin-based resin foam has coarse and uneven air bubbles to deteriorate moldability, while if the MI is too high, the foaming ability of the foamable sheet is decreased to give a crosslinked polyolefin-based resin foam poor in flexibility, or the crosslinked polyolefin-based resin foam has coarse and uneven air bubbles to deteriorate moldability, and therefore the MI is preferably 1 to 30 g/10 min. The MI of the polypropylene-based resin in the present invention refers to the one determined under the conditions of a temperature of 230° C. and a loading of 21.2 N in accordance with JIS K 7210.

The content of the isotactic homopolypropylene in the polyolefin-based resin is preferably 7 to 40% by weight because if its content is too low, the resulting crosslinked polyolefin-based resin foam is poor in strength at high temperatures, to undergo sheet cutting, resin leakage or the like during molding, while if the content is too high, the resulting crosslinked polyolefin-based resin foam is poor in elongation at ordinary temperatures.

The melting energy at 140° C. or more, contained in the melting energy of the crosslinked polyolefin-based resin foam according to the present invention per unit weight, is limited to 28 to 50 mJ/mg. This is because if the melting energy at 140° C. or more, contained in the melting energy per unit weight, is too low, high-temperature melting crystalline components are decreased, and thus the heat resistance and mechanical strength of the crosslinked polyolefin-based resin foam are lowered to deteriorate moldability, while if the melting energy is too high, the elongation of the crosslinked polyolefin-based resin foam at ordinary temperatures is decreased.

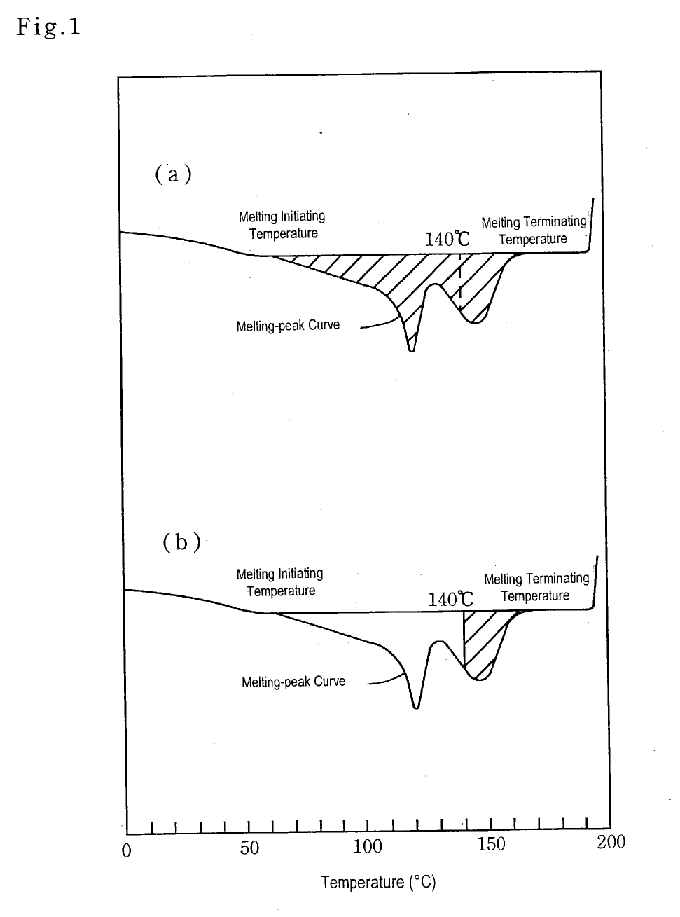

Now, the melting energy of the crosslinked polyolefin-based resin foam per unit weight will be described with reference to FIG. 1. The melting energy of the crosslinked polyolefin-based resin foam per unit weight is obtained by dividing, with sample weight (mg), calorific value (mJ) obtained from the area of its melting peak in differential scanning calorimetry. The area of the melting peak in differential scanning calorimetry refers to the area (shaded area in (a) of FIG. 1) enclosed by the melting peak curve measured in accordance with JIS K7211 and the straight line between the melting initiating temperature and the melting terminating temperature in the melting peak curve.

An example of the specific process of measuring the melting energy of the crosslinked polyolefin-based resin foam per unit weight includes a process which involves measuring a melting-peak curve in differential scanning calorimetry using a differential scanning calorimeter (trade name: “SSC5200”) manufactured by Seiko Denshi Co., Ltd., then calculating a melting-peak area from the melting peak curve, and obtaining the calorific value from the melting-peak area.

The melting energy at 140° C. or more, contained in the melting energy of the crosslinked polyolefin-based resin foam per unit weight refers to a value obtained by calculating the percentage of the melting-peak area at 140° C. or more (shaded area in (b) of FIG. 1) relative to the melting-peak area in differential scanning calorimetry and then multiplying, by the above percentage, the calorific value obtained from the melting-peak area in differential scanning calorimetry.

An example of the specific process of calculating the percentage of the melting-peak area at 140° C. or more (shaded area in (b) of FIG. 1) relative to the melting-peak area in differential scanning calorimetry (shaded area in (a) of FIG. 1) includes a process wherein the melting-peak curve in differential scanning calorimetry is copied on paper, then the area enclosed by the melting-peak curve and the straight line between the melting initiating temperature and the melting terminating temperature in the melting-peak curve is removed by cutting from the copy, the weight of the removed paper (mg) is measured, while the weight of the paper (mg) in the region at 140° C. or more in the removed paper is measured, and the weight of the paper in the region at 140° C. or more is divided by the weight of the whole of the removed paper.

If the apparent density of the crosslinked polyolefin-based resin foam is too low, the mechanical strength is decreased, while if the apparent density is too high, the flexibility is decreased and weight is increased, and therefore the apparent density is preferably 0.02 to 0.2 g/cm³, more preferably 0.03 to 0.1 g/cm³. The apparent density of the crosslinked polyolefin-based resin foam refers to the one determined according to JIS K6767.

Further, if the elongation of the crosslinked polyolefin-based resin foam at 20° C. is too low, the crosslinked polyolefin-based resin foam does not follow smoothly in the molding direction, thus causing sheet cutting easily, while if the elongation is too high, the heat resistance of the crosslinked polyolefin-based resin foam is easily lowered, and therefore the elongation is preferably 200 to 400%.

Further, if the elongation of the crosslinked polyolefin-based resin foam at 160° C. is too low, the crosslinked polyolefin-based resin foam easily undergoes resin leakage at the corner during molding, particularly stamping molding, while if the elongation is too high, the heat resistance of the crosslinked polyolefin-based resin foam is decreased, and therefore the elongation is preferably 130 to 300%.

More preferably, the elongation of the crosslinked polyolefin-based resin foam at 20° C. is 200 to 400%, and the elongation thereof at 160° C. is 130 to 300%.

The elongation of the crosslinked polyolefin-based resin foam at 20° C. refers to the one determined by the following process. That is, the crosslinked polyolefin-based resin foam is used to prepare two test specimens, one of which is a test specimen in the form of a flat rectangle which is longer in the MD direction (direction of extrusion of the resin) assumed to be the lengthwise direction, the other of which is a test specimen in the form of a flat rectangle which is longer in the TD direction (direction orthogonal to the MD direction) assumed to be the lengthwise direction. Then, the average elongation of the two test specimens is determined by measurement in the same manner as in Method A in JIS K6767 except that the measurement temperature is changed to 20° C. This average is referred to as elongation of the crosslinked polyolefin-based resin foam at 20° C.

The elongation of the crosslinked polyolefin-based resin foam at 160° C. refers to the one determined by the following process. That is, the crosslinked polyolefin-based resin foam is used to prepare two test specimens, one of which is a test specimen in the form of a flat rectangle which is longer in the MD direction (direction of extrusion of the resin) assumed to be the lengthwise direction, the other of which is a test specimen in the form of a flat rectangle which is longer in the TD direction (direction orthogonal to the MD direction) assumed to be the lengthwise direction. Then, the average elongation of the two test specimens is determined by measurement in the same manner as in Method A in JIS K6767 except that the measurement temperature is changed to 160° C. This average is referred to as elongation of the crosslinked polyolefin-based resin foam at 160° C.

Further, if the strength at 100% elongation of the crosslinked polyolefin-based resin foam is too low, air bubbles in the crosslinked polyolefin-based resin foam are broken at the time of molding, and the surface of the resulting molded article is easily made uneven, while if the elongation is too high, its molded article obtained by molding the crosslinked polyolefin-based resin foam may be warped with time, so that the strength at 100% elongation is 0.25 to 0.40 MPa at 120° C. and 0.07 to 0.20 MPa at 160° C.

The strength at 100% elongation of the crosslinked polyolefin-based resin foam at 120° C. refers to the one determined by the following process. That is, the crosslinked polyolefin-based resin foam is used to prepare two test specimens, one of which is a test specimen in the form of a flat rectangle which is longer in the MD direction (direction of extrusion of the resin) assumed to be the lengthwise direction, the other of which is a test specimen in the form of a flat rectangle which is longer in the TD direction (direction orthogonal to the MD direction) assumed to be the lengthwise direction. Then, the average tensile strength of the two test specimens is determined by measurement in the same manner as in Method A in JIS K6767 except that the measurement temperature is changed to 120° C. This average is referred to as strength at 100% elongation of the crosslinked polyolefin-based resin foam at 120° C.

The strength at 100% elongation of the crosslinked polyolefin-based resin foam at 160° C. refers to the one determined by the following process. That is, the crosslinked polyolefin-based resin foam is used to prepare two test specimens, one of which is a test specimen in the form of a flat rectangle which is longer in the MD direction (direction of extrusion of the resin) assumed to be the lengthwise direction, the other of which is a test specimen in the form of a flat rectangle which is longer in the TD direction (direction orthogonal to the MD direction) assumed to be the lengthwise direction. Then, the average tensile strength of the two test specimens is determined by measurement in the same manner as in Method A in JIS KG767 except that the measurement temperature is changed to 160° C. This average is referred to as strength at 100% elongation of the crosslinked polyolefin-based resin foam at 160° C.

Accordingly, it is more preferable that the elongation of the crosslinked polyolefin-based resin foam is 200 to 400% at 20° C. and 130 to 300% at 160° C., while the strength at 100% elongation is 0.25 to 0.40 MPa at 120° C. and 0.07 to 0.20 MPa at 160° C.

The process for producing the crosslinked polyolefin-based resin foam described above is not particularly limited, and a known process for producing foam is used, and an example thereof includes a producing process which comprises supplying an extruder with a foamable resin composition comprising a thermally degradable foaming agent and if necessary additives such as a crosslinking assistant added to the polyolefin-based resin containing 20 to 60% by weight of polyethylene-based resin, melt-kneading the composition, extruding it into a foamable sheet through the extruder, irradiating at least one side of the resulting foamable sheet, preferably both sides of the foamable sheet, with ionizable radiations to crosslink the sheet, and foaming the foamable sheet by heating at a temperature higher than the decomposition temperature of the thermally degradable foaming agent.

The thermally degradable foaming agent is not particularly limited insofar as it is used conventionally in production of foam, and examples thereof include azodicarbonamide, dinitrosopentamethylenetetramine, hydrazide dicarbonamide, barium azodicarboxylate, nitrosoguanidine, p,p-oxybisbenzenesulfonylsemicarbazide, benzenesulfonylhydrazide, N, N-dinitrosopentamethylene tetramine, toluenesulfonylhydrazide, 4,4-oxybis(benzenesulfonylhydrazide), azobisisobutyronitrile and the like, and these may be used alone or in combination thereof.

The amount of the thermally degradable foaming agent added is suitably regulated, but if the amount is too low, foaming may not occur, while if the amount is too high, air bubbles are easily broken, so the amount of the thermally degradable foaming agent is preferably 1 to 50 parts by weight, more preferably 5 to 20 parts by weight, relative to 100 parts by weight of the above-described polyolefin-based resin.

Further, the crosslinking assistant is not particularly limited insofar as it is used conventionally for production of foam, and examples thereof include divinyl benzene, trimethylolpropane trimethacrylate, 1,9-nonanediol dimethacrylate, 1,10-decanediol dimethacrylate, triallyl trimellitate, triallyl isocyanurate, ethyl vinyl benzene, neopentyl glycol dimethacrylate, triallyl 1,2,4-benzenetricarboxylate, 1,6-hexanediol dimethacrylate and the like, and these may be used alone or in combination thereof.

The amount of the crosslinking assistant added is suitably regulated, but if the amount is too low, the effect of the crosslinking assistant added may not be achieved, while if the amount is too high, crosslinking of the foamable sheet may proceed significantly at the time of crosslinkage to cause a reduction in the foaming ability, and therefore the amount of the crosslinking assistant is preferably 0.5 to 30 parts by weight, more preferably 2.0 to 15 parts by weight, relative to 100 parts by weight of the polyolefin-based resin.

The ionizable radiations are not particularly limited insofar as they are used conventionally for production of foam, and examples thereof include α-rays, β-rays, γ-rays, electron beams and the like.

The irradiation with ionizable radiations is preferably irradiation with ionizable radiations different in accelerating voltage. Specifically, it is preferable to irradiate the foamable sheet simultaneously or separately with a low-energy ionizable radiation at an accelerating voltage of 200 to 400 kV and a high-energy ionizable radiation at a higher accelerating voltage than that of the low-energy ionizable radiation, and from the viewpoint of the efficiency of crosslinking of the foamable sheet, it is more preferable to irradiate the sheet first with a high-energy ionizable radiation and then with a low-energy ionizable radiation.

Because too high or low irradiation with the low-energy ionizable radiation causes a reduction in the moldability of the resulting crosslinked polyolefin-based resin foam, the irradiation is preferably 0.5 to 10 Mrad.

If the irradiation with the high-energy ionizable radiation is too low, the moldability of the resulting crosslinked polyolefin-based resin foam may be deteriorated, while if the irradiation is too high, the surface properties of the crosslinked polyolefin-based resin foam may be deteriorated, and therefore the irradiation is preferably 0.5 to 10 Mrad.

If the irradiation of the ionizable radiations in total is too low, the moldability of the resulting crosslinked polyolefin-based resin foam may be deteriorated, while if the irradiation is too high, the surface properties of the resulting crosslinked polyolefin-based resin foam may be deteriorated, and therefore the irradiation is preferably 1 to 20 Mrad.

The amount of the crosslinking assistant added and the irradiation with the ionizable radiation are regulated depending on the gel fraction of the crosslinked polyolefin-based resin foam, and specifically they are regulated such that the gel fraction of the crosslinked polyolefin-based resin foam becomes preferably 20 to 75% by weight, more preferably 30 to 65% by weight.

The gel fraction of the crosslinked polyolefin-based resin foam is determined by weighing the crosslinked polyolefin-based resin foam (A g), then immersing it in xylene at 120° C. for 24 hours, filtering it through a 200-mesh wire mesh, vacuum-drying insolubles on the wire mesh, measuring the dry weight (B g) of the insolubles and calculating the gel fraction from the following equation:

Gel fraction (% by weight)=100×(B/A)

Examples of additives other than the crosslinking assistant include: antioxidants based on phenol such as 2,6-di-t-butyl-p-cresol, based on sulfur such as dilauryl thiodipropionate, and based on phosphorus or amine; metal toxicity inhibitors such as methyl benzotriazole; fire retardants based on phosphorus, nitrogen, halogen or antimony, or a mixture thereof; fillers; antistatic agents; pigments; and the like.

Then, the crosslinked polyolefin-based resin foam is provided with a skin material laminated on one side thereof and molded into an article of desired shape. In particular, when the crosslinked polyolefin-based resin foam is to be used in interior materials for automobiles, the crosslinked polyolefin-based resin foam is molded preferably by stamping molding.

The mode of stamping molding includes, for example, the mode (1) which involves laminating a skin material on one side of the crosslinked polyolefin-based resin foam to form a composite sheet, arranging the composite sheet in an opening between male and female molds, clamping the male and female molds while allowing cracking to remain, then feeding a molten thermoplastic resin as a base material to the crosslinked polyolefin-based resin foam in the cavity formed between the male and female molds, and thereafter clamping the male and female molds completely, whereby the composite sheet and the molten thermoplastic resin are formed in a desired shape in the cavity while a base layer made of the thermoplastic resin is laminated integrally on the crosslinked polyolefin-based resin foam in the composite sheet, the mode (2) which involves arranging a composite sheet including a skin material laminated on one side of the crosslinked polyolefin-based resin foam, on a female mold such that the crosslinked polyolefin-based resin foam is placed at the side of the female mold, before or after feeding a molten thermoplastic resin as a base material to the female mold, thereafter clamping the male and female molds completely, whereby the composite sheet and the molten thermoplastic resin are formed in a desired shape in the cavity while a base layer made of the thermoplastic resin is laminated integrally on the crosslinked polyolefin-based resin foam in the composite sheet, and the mode (3) which involves arranging a composite sheet including a skin material laminated on one side of the crosslinked polyolefin-based resin foam, in an opening on between male and female molds such that the crosslinked polyolefin-based resin foam is directed upwards, arranging a molten thermoplastic resin as a base material on the crosslinked polyolefin-based resin foam, and thereafter clamping the male and female molds completely, whereby the composite sheet and the molten thermoplastic resin are formed in a desired shape in the cavity while a base layer made of the thermoplastic resin is laminated integrally on the crosslinked polyolefin-based resin foam in the composite sheet. Examples of the thermoplastic resin includes polyolefin-based resin such as polypropylene-based resin and polyethylene-based resin.

The skin material is not particularly limited, and examples thereof include: synthetic resin sheets such as polyolefin-based resin sheet, soft polyvinyl chloride-based resin sheet and thermoplastic elastomer sheet; and a non-woven fabric, textile or knitted fabric made of synthetic fibers such as polyester-based fibers, polyamide-based fibers or polyacrylate-based fibers or naturally occurring fibers such as cellulose-based fibers.

The skin material is preferably integrally laminated by heat lamination or via an adhesive on the crosslinked polyolefin-based resin foam before stamping molding, but the skin material may be integrated with the crosslinked polyolefin-based resin foam by heat of the molten thermoplastic resin.

When only one side of the foamable sheet is irradiated with the low-energy ionizable radiation in the process of producing the crosslinked polyolefin-based resin foam, the molten thermoplastic resin is fed preferably to that side of the crosslinked polyolefin-based resin foam which corresponds to the foamable sheet surface irradiated with the low-energy ionizable radiation, whereby the deterioration of the crosslinked polyolefin-based resin foam by heat, pressure, shear strength at the time of molding can be minimized, and the cushioning properties and flexibility of the crosslinked polyolefin-based resin foam can be prevented from being deteriorated.

Embodiments

(Embodiments 1 to 3, Comparative Embodiments 1 to 5)

Linear low-density polyethylene (density: 0.920 g/cm³, MI: 2.0 g/10 min.), isotactic homopolypropylene (MI=15 g/10 min.) and an ethylene-propylene random copolymer (ethylene content: 3.2% by weight, MI=2.0 g/10 min.) in the predetermined compounding amounts shown in Table 1, 10 parts by weight of azodicarbonamide, 3.0 parts by weight of trimethylolpropane trimethacrylate and effective amounts of 2,6-di-t-butyl-p-cresol, dilauryl thiodipropionate and methyl benzotriazole were fed to a twin-screw extruder, melt-kneaded at a temperature of 190° C. and extruded into a foamable sheet of predetermined thickness (about 1 mm).

Both sides of the resulting foamable sheet were irradiated respectively with 3 Mrad electron beam at an accelerating voltage of 700 kV and then both sides of the foamable sheet were irradiated respectively with 3 Mrad electron beam at an accelerating voltage of 300 kV.

The crosslinked foamable sheet was heated and foamed by passing it a foaming oven kept at about 250° C. by hot air and an infrared heater, to obtain a crosslinked polyolefin-based resin foam sheet. The crosslinked polyolefin-based resin foam was cut in a direction orthogonal to the direction of extrusion, and the cut was approximately rectangular with longer width.

(Embodiment 4)

Fifty parts by weight of linear low-density polyethylene (density: 0.920 g/cm³, MI: 2.0 g/10 min.), 12 parts by weight of isotactic homopolypropylene (MI=15 g/10 min.), 38 parts by weight of an ethylene-propylene random copolymer (ethylene content: 3.2% by weight, MI=2.0 g/10 min.), 10 parts by weight of azodicarbonamide, 3.0 parts by weight of trimethylolpropane trimethacrylate and effective amounts of 2,6-di-t-butyl-p-cresol, dilauryl thiodipropionate and methyl benzotriazole were fed to a twin-screw extruder, melt-kneaded at a temperature of 190° C. and extruded into a foamable sheet of predetermined thickness (about 1 mm).

Both sides of the resulting foamable sheet were irradiated respectively with 2.5 Mrad electron beam at an accelerating voltage of 700 kV and then both sides of the foamable sheet were irradiated respectively with 3 Mrad electron beam at an accelerating voltage of 300 kV.

The crosslinked foamable sheet was heated and foamed by passing it a foaming oven kept at about 250° C. by hot air and an infrared heater, to obtain a crosslinked polyolefin-based resin foam sheet. The crosslinked polyolefin-based resin foam was cut in a direction orthogonal to the direction of extrusion, and the cut was approximately rectangular with longer width.

The melting energy at 140° C. or more contained in the melting energy of the resulting crosslinked polyolefin-based resin foam sheet per unit weight, the apparent density, the elongation at 20° C. and 160° C., the strength at 100% elongation at 120° C. and 160° C., and the thickness are shown in Table 1.

The elongation of the crosslinked polyolefin-based resin foam sheet, obtained in Comparative Embodiment 4, did not reach 100% at 160° C., so its strength at 100% elongation at 160° C. could not be measured.

Then, the moldability of the crosslinked polyolefin-based resin foam sheet was measured in the following manner. That is, a soft polyvinyl chloride-based resin sheet of 0.7 mm in thickness was laminated integrally on one surface of the crosslinked polyolefin-based resin foam sheet via an adhesive, to prepare a composite sheet.

Then, the composite sheet was arranged between a female mold having a concave of diameter 100 mm×depth 50 mm and a male mold having a convex corresponding to the concave of the female mold such that the crosslinked polyolefin-based resin foam sheet was placed at the side of the female mold.

Thereafter, a molten polypropylene-based resin at about 200° C. was fed to the concave of the female mold, and subjected to stamping molding by clamping both the male and female molds, to give a molded cylindrical closed-end article.

The molded articles thus obtained were evaluated in the following manner, and the results are shown in Table 1.

[Retention of Thickness]

The thickness (remaining thickness) of the crosslinked polyolefin-based resin foam sheet in the molded article was measured.

[Surface Conditions (Pockmarks on the Surface)]

The surface of the molded article was observed with naked eyes, and the soft polyvinyl chloride-based resin sheet having a surface which was free of unevenness with pockmarks was given ◯, the one having a surface which was slightly uneven with pockmarks was given Δ, and the one having a surface which was significantly uneven with pockmarks was given X.

[Resin Leakage]

The corner of the molded article was cut at plural sites, and the cut was observed with naked eyes, and the article wherein the crosslinked polyolefin-based resin foam sheet was not invaded by the polypropylene-based resin was given ◯, the article wherein the crosslinked polyolefin-based resin foam sheet was invaded at few sites by the polypropylene-based resin was given Δ, and the article wherein the crosslinked polyolefin-based resin foam sheet was invaded at many sites by the polypropylene-based resin was given X. The molded article obtained from the crosslinked polyolefin-based resin foam sheet in Comparative Embodiment 4 underwent sheet cutting at the time of stamping, and thus the resin leakage could not be evaluated.

[Sheet Cutting]

The corner of the molded article was cut at plural sites, and the cut was observed with naked eyes, and the article wherein the crosslinked polyolefin-based resin foam sheet was not broken was given ◯, the article wherein the crosslinked polyolefin-based resin foam sheet was slightly broken was given Δ, and the article wherein the crosslinked polyolefin-based resin foam sheet was broken at many sites was given X.

[Warp of the Molded Article]

The bottom of the molded article (site corresponding to the convex edge of the male mold) was observed, and the article whose warp was less than 1 mm was given ◯, and the article whose warp was 1 mm or more was given X.

TABLE 1

| | | Embodiments | | | | Comparative Embodiments | | | | |
|---|---|---|---|---|---|---|---|---|---|---|
| | | 1 | 2 | 3 | 4 | 1 | 2 | 3 | 4 | 5 |
| Compounding | | | | | | | | | | |
| amount | | | | | | | | | | |
| (parts by weight) | | | | | | | | | | |
| Linear low-density | | 45 | 25 | 45 | 50 | 10 | 75 | 55 | 50 | 46 |
| polyethylene | | | | | | | | | | |
| Isotactic homopolypropylene | | 10 | 10 | 30 | 12 | 10 | 25 | — | 50 | 4 |
| Ethylene-propylene random | | 45 | 65 | 25 | 38 | 80 | — | 45 | — | 50 |
| copolymer | | | | | | | | | | |
| Crosslinked | | | | | | | | | | |
| polyolefin-based | | | | | | | | | | |
| resin foam sheet | | | | | | | | | | |
| Melting energy at 140° C. | | 29.1 | 36.9 | 44.3 | 28.7 | 42.7 | 31.8 | 17.8 | 57.6 | 23.7 |
| or more (mJ/mg) | | | | | | | | | | |
| Apparent density (g/cm²) | | 0.068 | 0.067 | 0.068 | 0.067 | 0.067 | 0.068 | 0.066 | 0.066 | 0.067 |
| Elongation (%) | 20° C. | 310 | 300 | 210 | 320 | 300 | 260 | 370 | 160 | 340 |
| | 160° C. | 170 | 150 | 135 | 180 | 120 | 80 | 190 | 80 | 195 |
| Strength at 100% | 120° C. | 0.30 | 0.32 | 0.39 | 0.26 | 0.35 | 0.22 | 0.18 | 0.42 | 0.24 |
| elongation (MPa) | 160° C. | 0.12 | 0.13 | 0.19 | 0.08 | 0.09 | 0.10 | 0.06 | — | 0.08 |

| | | | | | | | | | |
|---|---|---|---|---|---|---|---|---|---|
| Thickness (mm) | 3.0 | 3.0 | 3.1 | 3.0 | 3.1 | 3.1 | 3.1 | 3.0 | 3.1 |
| Molded article | | | | | | | | | |
| Retention of thickness (mm) | 2.1 | 2.2 | 2.0 | 2.0 | 2.2 | 1.4 | 1.8 | 1.6 | 1.8 |
| Surface conditions | ◯ | ◯ | ◯ | ◯ | ◯ | Δ | X | ◯ | X |
| Resin leakage | ◯ | ◯ | ◯ | ◯ | X | X | X | — | X |
| Sheet cutting | ◯ | ◯ | ◯ | ◯ | Δ | Δ | Δ | X | Δ |
| Warp of the molded article | ◯ | ◯ | ◯ | ◯ | ◯ | ◯ | ◯ | X | ◯ |

What is claimed is:

1. A crosslinked polyolefin-based resin foam comprising a polyolefin-based resin which contains 20 to 60% by weight of a polyethylene-based resin, the crosslinked polyolefin-based resin foam having the melting energy of 28 to 50 mJ/mg at 140° C. or more contained in the melting energy per unit weight (calorific value obtained from the area of its melting peak in differential scanning calorimetry/weight).

2. The crosslinked polyolefin-based resin foam according to claim 1, comprising 7 to 40% by weight of isotactic homopolypropylene having a melt index of 1 to 30 g/10 min.

3. The crosslinked polyolefin-based resin foam according to claim 1, wherein the elongation is 200 to 400% at 20° C. and 130 to 300% at 160° C., and the strength at 100% elongation is 0.25 to 0.40 MPa at 120° C. and 0.07 to 0.20 MPa at 160° C.

4. A process for producing a crosslinked polyolefin-based resin foam, comprising feeding 100 parts by weight of a polyolefin-based resin containing 20 to 60% by weight of a polyethylene-based rein and 1 to 50 parts by weight of a thermally degradable foaming agent to an extruder, melting and kneading the mixture, extruding it into a foamable sheet, irradiating at least one side of the foamable sheet simultaneously or separately with a low-energy ionizable radiation at an accelerating voltage of 200 to 400 kV and a high-energy ionizable radiation at an accelerating voltage higher than that of the low-energy ionizable radiation, to crosslink the foamable sheet, and foaming the foamable sheet by heating at a temperature higher than the decomposition temperature of the thermally degradable foaming agent, to produce a crosslinked polyolefin-based resin foam having 28 to 50 mJ/mg of the melting energy at 140° C. or more contained in the melting energy per unit weight (calorific value obtained from the area of its melting peak in differential scanning calorimetry/weight).

5. An interior material for automobiles which comprises a skin material laminated integrally on one side of a crosslinked polyolefin-based resin foam and a base layer made of thermoplastic resin laminated integrally on the other side, the crosslinked polyolefin-based resin foam comprising a polyolefin-based resin containing 20 to 60% by weight of a polyethylene-based resin, the crosslinked polyolefin-based resin foam having the melting energy of 28 to 50 mJ/mg at 140° C. or more contained in the melting energy per unit weight (calorific value obtained from the area of its melting peak in differential scanning calorimetry/weight).
